(19) United States
(12) Patent Application Publication
(10) Pub. No.: US 2017/0189272 A1
(43) Pub. Date: Jul. 6, 2017

(54) DEVICE FOR DELIVERING A SOLUBLE PRODUCT WITH A STRAW, IN PARTICULAR FOR CHILDREN AND/OR THE ELDERLY, ADAPTED CARTRIDGE

(71) Applicant: UNITHER PHARMACEUTICALS, AMIENS (FR)

(72) Inventors: Eric Goupil, Paris (FR); Marc Maury, Saint Medard En Jalles (FR)

(21) Appl. No.: 14/984,675

(22) Filed: Dec. 30, 2015

(51) Int. Cl. A61J 7/00

(52) U.S. Cl. CPC A61J 7/0038; A61J 7/00; A61J 2205/30

(57) ABSTRACT

A device for delivering a soluble product (28) that includes a straw (10), includes a body (12), element (14) for accommodating at least one cartridge (16) that contains the soluble product, in solid form. The adapted cartridges (16) as well as a particular packaging are also described.

This invention relates to a device for delivering a soluble product with a straw, in particular a medication, even more particularly for children, whose active ingredient is to be metered based on weight.

The invention also covers the cartridge that is adapted to said device.

The problem of administering medications to children, to the elderly, and even to certain adolescents in tablet or capsule form is known.

This is even more problematic when the product has to be metered based on weight, with these products being in liquid form.

Therefore, use is often made of liquid formulas, semi-liquid formulas, which in turn have their own problems as well.

Actually, the spoon is not simple because it is necessary to adjust a volume in the spoon prior to intake. The child can turn his head away during intake and spill a portion so that the administrator does not have the possibility of determining the quantity taken; therefore, it may be no longer possible to determine the additional quantity to be administered.

Another problem is that of the products themselves, which are less well preserved in liquid form for many of them, and in particular the antibiotics.

They are therefore often presented in the form of bottles containing a powder. It is then advisable to add an excipient, most often water, to obtain a solution or a suspension that is to be taken orally.

The advantage is therefore that the product is stable in dry form and can be preserved over longer periods than the solutions in liquid form that are to be taken orally, in awaiting its preparation.

It is for this reason in particular that the antibiotics are often the object of extemporaneous preparations.

Nevertheless, the addition of excipient is difficult to meter because either there is too much of it and the antibiotic is diluted or it is necessary to administer it several times to adjust the addition, in particular because the powder is often micronized in such a way as to make possible an easy dilution, making wetting difficult because of the air contained therein.

Imprecisions of metering are therefore observed regularly.

Even though an extemporaneous preparation is used, once the excipient is added, the bottle, despite everything, has to be kept cold to preserve the stability of its contents, and it is understood that the observance of the treatment is made more difficult for the patient.

To improve intake, syringes or spoons or graduated capsules have been used, but this does not make an easy external examination possible and remains a task that is always a bit problematic. In particular, in the case of taking multiple medications, it is advisable to use the proper metering device because the doses vary from one to the next, leading to possible errors and backed up by warnings issued by numerous health safety offices.

During administration, the bottle remains open, and this can provide the same child or another a chance to access the contents, the “child safety” cap not being able to perform its role, primarily during a moment of inattention or distraction.

It has also been noted that certain medical products often have unpleasant tastes that do not make it easy for a child to take them. However, the agents responsible for these unpleasant tastes are often antimicrobial preservatives that ensure the microbiological stability of the thus prepared medication. They are therefore revealed and recognized only during the absorption of already prepared liquid or semi-liquid solutions.

The solid form that is to be diluted at the time of intake seems to be the best solution, but then it is necessary to provide single-dose packets with quantities of active ingredient based on each weight range of the child.

As for dilution in a glass, it is also known that this is not particularly fun and especially that the dilution has to be adjusted to the child's momentary desire to drink it. If the active ingredient has been diluted in a large quantity of water and the child no longer wants to drink, this can prove difficult.

Thus, the straw that includes flavoring means, in such a way as to flavor the liquid circulating in the straw as the liquid passes into said straw, is old since it dates back to approximately the 1950s.

The international patent application WO 03/101226 describes a straw that contains flavoring balls in solid form, arranged in a straw body.

The user can thus use a volume of milk, water, or any other liquid and flavor this liquid when it passes through the straw as the consumer sucks it up and when it comes into contact with the balls or the powder.

It is therefore possible to imagine applying this device to the delivery of medication to children, the elderly, or those having difficulties in drinking.

This suggestion is furthermore included in this same prior art application.

As a result, the product remains in anhydrous form during its storage phase, thus preserving all of its properties. The active ingredient is brought into contact with the excipient only at the time of consumption.

The device is also fun to use.

From the taste standpoint, it is not necessary to provide any preserver of microbial integrity, de facto eliminating the problem of their unpleasant tastes.

The reconstitution stage is also eliminated because the active ingredient is consumed as the excipient is taken in by the patient. It is noted on this subject that the excipient can be water, but also milk, fruit juice, or else a fruit syrup, making intake even easier.

This administration method is apparently perfectly suitable, but there are still problems with this mode of administration.

Actually, it is necessary to provide metered straws in a way adapted to each child when the medication is to be taken based on the child's weight. Metered straws would therefore be necessary for each range of weight.

This is in particular one of the reasons for which there is currently no medicinal straw. The stocks to be maintained both in private pharmacies and in the pharmacies of hospitals would quickly become very large, making this approach financially unrealistic.

In addition, there is no visual means for determining whether the quantity of excipient passed through the straw is sufficient to dissolve the entire dose of active ingredient that is necessary.

More to the point, there is a problem in adapting the doses based on the weight of the child or the patient in a general way.

This invention proposes a device for delivering a product, in particular a medication, in the form of a straw, which preserves the advantages of the prior art mentioned above, in particular shelf life, the absence of biological preservation agents, and which makes it possible to adjust the active ingredient dose based on needs, which is perfectly readable and safe and which limits the stocks of products for pharmacists, distributors, and manufacturers.

In addition, the device according to this invention makes it possible to propose delivery devices designed to make possible the delivery of multiple active ingredients; this occurs for polymedicated patients, typically the elderly.

For this purpose, the device is now described with respect to the accompanying drawings, drawings in which the various figures show:

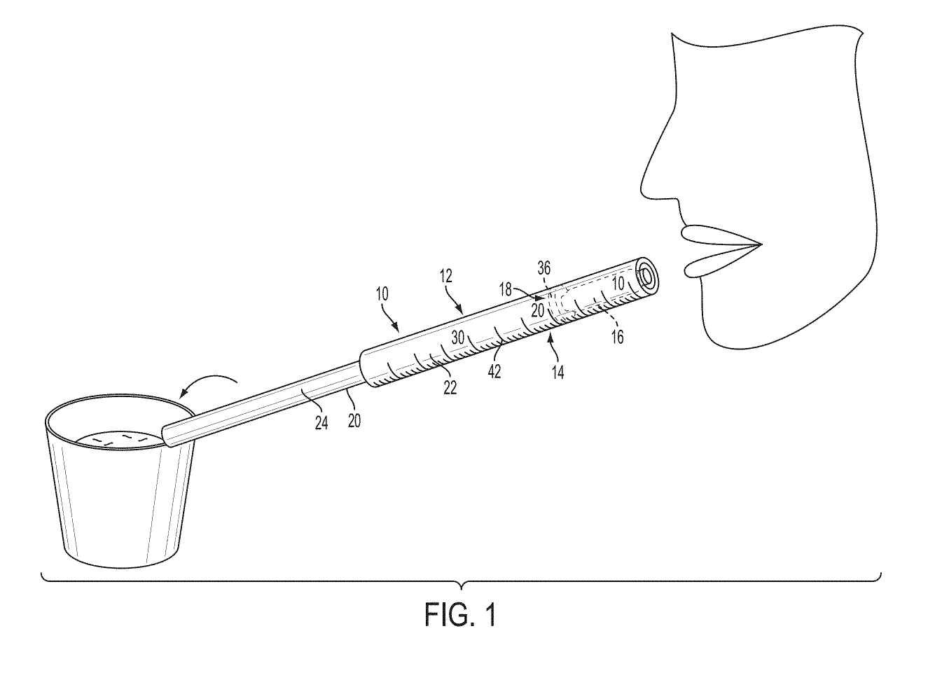

FIG. 1: A perspective view of a delivery device according to this invention,

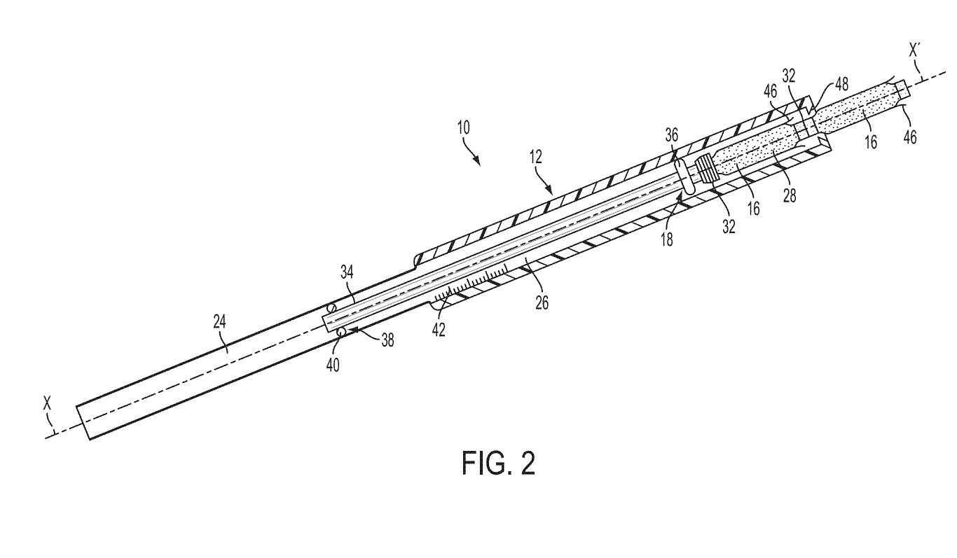

FIG. 2: A longitudinal cutaway view of the device of FIG. 1,

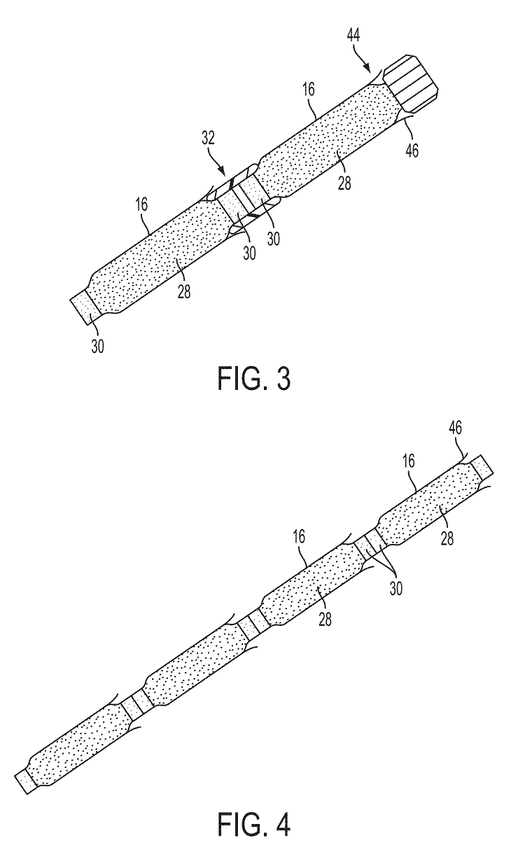

FIG. 3: A view of the connecting means of the cartridges used in the delivery device of FIG. 1,

FIG. 4: A view of the cartridges used for employing the delivery device according to this invention.

FIG. 1 shows a straw 10 that comprises a body 12, means 14 for accommodating at least one cartridge 16, and display means 18.

The body 12 comprises two elements that are linked together in a monolithic manner. The first element 20 is a plunger, and the second element 22 pertains to the mouth.

The first element 20 comprises, in a known way, a cylindrical, hollow, tubular portion 24, whose diameter is compatible with the flow envisioned, on the order of 2 to 5 mm.

The second buccal element 22 comprises a hollow housing 26 that is designed to accommodate at least one cartridge 16.

This second buccal element 22 is open at the top in such a way as to make it possible to be taken by mouth at least by a child.

This second buccal element 22 should therefore have dimensions that are also adapted to the mouth of a child, on the order of 8 to 10 mm.

The hollow housing 26 is connected to the first element 20 and is in direct communication with the cylindrical, hollow, and tubular portion 24.

Thus, the straw 10 is open at its two ends, and a continuous longitudinal central channel of the axis XX′ passes through it.

Each cartridge 16, in the adopted embodiment, is of cylindrical, hollow shape, open at its two ends.

As also shown in FIGS. 2 and 3, each cartridge 16 comprises a soluble product 28, in particular at least one pharmaceutical active ingredient, introduced in solid form in said cartridge 16.

This active ingredient is integrally soluble in a liquid, in this case in water.

So as not to ingest the solid powder directly before solubilization as previously explained in detail, a filter 30 is advantageously provided at each of the two ends of said cartridge.

Each cartridge 16 and/or the communication tube comprise(s) a connecting head 32. This connecting head 32 makes possible a fluidtight connection either with the device itself or with another cartridge.

The display means 18 comprise a communication tube 34, an index 36, and sealing means 38.

The communication tube 34 is arranged in the cylindrical, hollow, tubular part 24 of the first element 20. This communication tube 34 can slide into said hollow cylindrical part 24.

The communication tube 34 extends into the hollow housing 26 of the second buccal element 22 into which it also slides.

The index 36 is integral with the end of the communication tube 34 and more particularly with the end located in the hollow housing 26.

The sealing means 38 comprise an O-ring seal 40, inserted between the inside wall of the cylindrical, hollow, tubular part 24 of the first element 20 and the outside wall of the communication tube 34.

In an advantageous way, the straw 10 is produced from a transparent or at least translucent material; the index 36 is of such a color to make it possible to see it.

In addition, graduations 42 are made on the wall of the second buccal element 22. These graduations 42 are in particular weight graduations that correspond to ranges of weight of a child, in this case 10, 20, 30 kg.

In the embodiment shown, it is noted that the second buccal element 22 is provided for accepting at most three cartridges 16, each cartridge 16 making it possible to deliver the dose of active ingredient per 10 kg.

In an advantageous way, means 44 are provided for holding the cartridges after insertion within the hollow housing 26 of the second buccal element 22. These means can be of any nature whatsoever and in particular in the form of a flexible lug 46 that remains flattened against the outside wall of the cartridge 16 in one direction.

In the other direction, this lug 46 rises and presses against the wall of the hollow housing 26 and more particularly against an inside lip 48, made for this purpose in said hollow housing, forming a stop and preventing the extraction of said cartridge 16.

The operation of the device is as follows:

When an active ingredient is to be administered in particular to a child, based on weight or on the prescription, the individual responsible for administering the active ingredient selects the necessary number of cartridges 16.

In this regard, the cartridges can advantageously be presented in the form shown in FIG. 4. This is a packaging 50 in the form of a series of cartridges 16. This series can be flexible so as to make possible a winding in a ring. In this case, the packaging material will be a flexible or semi-rigid material.

The series is separable so as to make possible a sampling of 1, 2 or 3 cartridges in the case shown. These cartridges are then integral with one another.

In this case, it is necessary to use only a single connecting head 32 that is already integrated on the end of the communication tube 34.

When the user has sampled the number of cartridges corresponding to the weight of the child, in this case two cartridges, for example, for a child of 20 kilos, said cartridges are inserted into the hollow body 26.

The cartridges 16 penetrate and come into contact with the connecting head 32; the end of the first cartridge is fitted on in a fluidtight manner.

The O-ring seal 40 of the sealing means 38 ensures sufficient resistance to ensure this fitting.

The two cartridges 16 are inserted integrally, and the holding means 44 in the form of lugs 46 ensure clamping, in the direction of the withdrawal, because of the lip 48.

Depending on the pressure exerted with the thumb, for example, by the user on the cartridges, the communication tube 34 slides in translation in a fluidtight manner in the first cylindrical, hollow and tubular portion 24 of the first element 20.

The index 36, integral with said communication tube 34, also moves in the hollow part 26 of the second buccal element 22, and the patient can have confirmation by reading graduations 42 that the announced weight is indeed that of the child and therefore that the number of cartridges indeed corresponds to this weight.

The patient then immerses the free end of the first cylindrical, hollow and tubular portion 24 of the first element 20 in the liquid contained in a glass, for example.

He brings the free end of the second buccal element 22 to his mouth and sucks.

The liquid that is contained in the glass, subjected to a partial vacuum, moves into the first cylindrical, hollow and tubular portion 24 of the first element 20 and then abuts the O-ring seal that leads it into the communication tube 34; the liquid continues its movement through the two cartridges 16.

It dissolves the active ingredient or ingredients and the flavoring and/or solubilization excipients contained in said cartridges, in the form of powder, balls, or any other solid galenical form.

The liquid that is loaded with this or these active ingredient(s) is then absorbed by the patient.

Multiple improvements are possible.

The cartridges can comprise a dye making it possible to note the change in color when the entire active ingredient is dissolved and therefore absorbed.

In some cases, the soluble product in terms of this invention can also be partially soluble.

According to a variant, the solid active ingredient can be carried by an inert medium that remains in the cartridge, with only the active ingredient being soluble during the passage of the fluid in said cartridge.

The filter 30 that is provided in the embodiment has as its objective to hold the active ingredient(s) in solid form in said cartridges.

In a way that is also not to pollute the liquid contained in the glass, it is possible to use anti-return means in the form of a non-return valve in the communication tube; for example, a flexible membrane or a ball are quite suitable means.

In the same way, the embodiment shown was within the framework of a non-reusable device.

This invention certainly includes the option that the device can be reused. In this case, the holding means should be provided to make possible a voluntary withdrawal.

The device is then emptied of its cartridges and reused, after rinsing, with new cartridges.

1. Device for delivering a soluble product (28) that comprises a straw (10), comprising a body (12), means (14) for accommodating at least one cartridge (16) containing said soluble product (28), in solid form, characterized in that the body (12) comprises two elements that are linked together in a monolithic way, a first plunger element (20) and a second buccal element (22) and a movable communication tube (34) that is mounted to slide in these two elements.

2. Device for delivering a soluble product according to claim 1, wherein sealing means (38) are provided between said communication tube (34) and said first elements (20) and second elements (22).

3. Device for delivering a soluble product according to claim 2, wherein the sealing means (38) comprise an O-ring seal (40), inserted between the inside wall of the cylindrical, hollow, tubular part (24) of the first element (20) and the outside wall of said communication tube (34).

4. Device for delivering a soluble product according to claim 2, wherein the body (12) is made of transparent or translucent material and wherein it comprises display means (18).

5. Device for delivering a soluble product according to claim 4, wherein the display means (18) comprise an index (36) that is integral with the end of the communication tube (34) and graduations (42) made on said body.

6. Device for delivering a soluble product according to claim 1, wherein the means (14) for accommodating a cartridge (16) comprise a connecting head (32) that is provided for attaching to the end of the communication tube (34) and to the end of said cartridge (16).

7. Device for delivering a soluble product according to claim 1, wherein it comprises means (44) for holding cartridges (16).

8. Device for delivering a soluble product according to claim 7, wherein the means (44) for holding cartridges (16) comprise an inside lip (48), made in the hollow housing (26).

9. Device for delivering a soluble product according to claim 1, wherein it comprises at least one cartridge (16) that contains a soluble solid product (28), itself comprising at least one pharmaceutical active ingredient.

10. Cartridge that is adapted for being housed in the hollow housing (26) of the second buccal element (22) of the means (14) for accommodating the delivery device according to claim 1, wherein it comprises a body, open on its two ends, containing a soluble product (28), in solid form.

11. Cartridge that is adapted for the delivery device according to claim 10, wherein it comprises holding means (44) relative to the hollow housing (26) into which it has to be inserted.

12. Cartridge that is adapted for the delivery device according to claim 11, wherein the holding means (44) are in the form of lugs (46).

13. Cartridge that is adapted for the delivery device according to claim 10, wherein it comprises end filters (30).
